(19) United States
(12) Patent Application Publication
(10) Pub. No.: US 2002/0098409 A1
(43) Pub. Date: Jul. 25, 2002

(54) Safety vent for battery and method therefor

(76) Inventors: Gun Tack Oh, Kwangju (KR); Hee Sook Noh, Kwangju (KR); Min Young Han, Kwangju (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/776,725

(22) Filed: Feb. 6, 2001

(30) Foreign Application Priority Data
Nov. 24, 2000 (KR) 2000-70501

(51) Int. Cl. H01M 2/12

(52) U.S. Cl. 429/56; 29/623.5; 29/623.4

(57) ABSTRACT

Disclosed is a safety vent for a battery and a method therefor. The safety vent for the battery and the method therefor are able to safely draw off an internal pressure by virtue of a higher reliability in case of an abnormal rise in the internal pressure in the battery, reduce a production cost by virtue of a simpler manufacture process, and be applied to a narrow space in the battery with more ease.

According to the safety vent of the present invention, a vent hole is deposited at a bottom of a battery metal container. A vent plate is welded to an outside of the metal container at the position of the vent hole. A vent is formed on the vent plate. A weld zone between the vent plate and an inside and outside of the metal container is coated with phenolic resin.

### BACKGROUND OF THE INVENTION

1. Field of the Invention

The present invention generally relates to a safety vent for a battery and a method therefor, and more particularly, to a safety vent for a battery and a method therefor which are used to prevent the battery from being exploded in case of an abnormal rise in an internal pressure of the battery.

2. Description of the Related Art

In general, a battery is defined as a device for converting a chemical energy generated in the event of an electrochemical oxidation-reduction reaction of a chemical substances into an electric energy. The battery is classified depending on characteristics in use thereof into a primary battery which can not be used further after the energy therein is exhausted, and a rechargeable battery which can be repeatedly used after recharged.

With the recent rapid growth of electronics, communications and computer industries enabling products to have small-size, lightweight, and high performance, portable electric products including camcorders, cellular phone, notebook PC are widely used. There has been hence sought to develop a small-sized battery having lighter weight, longer life, higher reliability, and higher performance. It is the lithium primary and rechargeable batteries that arouse users' interest and attention by virtue of their correspondence to such demand.

Lithium is known as a substance having the greatest electric capacity per unit mass because it is the lightest in weight among metals, and as a material making the battery have a higher voltage because it has a higher thermodynamic oxidation-potential. Lithium has been studied for quite a long time as an anodic substance having the greatest potential for batteries which are requested to generate a maximum energy with a limited amount of chemical substances.

The lithium battery has an advantage of higher operating voltage, higher energy density and longer life, but also a disadvantage of higher risk of battery explosion in such an emergency state as short circuit, high rate discharge or heating because it has higher reactivity than other metals.

Therefore, in the conventional lithium battery, attempts has been directed toward devising measures capable of preventing the battery explosion or minimizing the damage even in the event of the battery explosion. This is because the lithium battery employs a safety vent.

The safety vent is characterized in that a portion of a battery case designed weaker than other portions is supposed to be first exploded if an internal pressure of the battery increases up to a predetermined value, thereby alleviating the internal pressure of the battery. In the case that the internal pressure is focused all at once and then the battery is separated and exploded into small broken pieces, the safety vent can prevent a possible heavier damage.

The safety vent has been developed to have various structures, shapes, and functions corresponding to the development of the battery. Structural characteristic of the general safety vent will be described herein below with reference to FIG. 1a and FIG. 1b

In general, the conventional battery is provided with a specific portion thinner than other portions thereon, that is to say, vent which is manufactured by being pressed in the form of “−” against a bottom of a battery armoring metal container as shown in FIG. 1a or against an outer face of the battery metal container 1b as shown in FIG. 1b. The conventional safety vent is designed to be exploded first in case of the battery explosion, thereby drawing off the internal pressure in the battery.

The conventional safety vent of this simple constitution, however, has a drawback that in some cases, the vent will not open under even a relatively high pressure since the pressure required to open the vent is not uniform, leaving something still to be desired to guarantee the safety in the event of the battery explosion.

FIG. 2 is a diagram illustrating a safety vent improved further than the safety vent in FIG. 1a and FIG. 1b. Referring to FIG. 2, the safety vent is comprised in a lid 3 covering a top of the battery.

The safety vent comprised in the lid 3 is manufactured into a double-pieced structure by etching the metal plate-shaped lid of 0.1 mm in thickness up to about 0.05 mm in depth to make a vent face, and cutting the vent face 4 to make slits of 0.02. to 0.03 mm in depth, whereby the slits are supposed to be first exploded if the internal pressure in the battery is high.

The safety vent manufactured in this manner has an advantage of having a relatively higher reliability since the pressure required to open the safety vent falls within the range 3 kgf of the design criteria, but also a disadvantage of making a perfect sealing difficult due to a thermal distortion of the metal plate-shaped lid generated when a positive terminal 6 is heat-sealed or insulated with or from the negative lid 3 by means of a glass in the course of manufacturing the battery.

To avoid this problem, the positive terminal 6 is fixed into a thick metal ring 7 and then the positive terminal 6 and the metal ring 7 is heat-sealed or insulated with glass 8, followed by welding the metal ring 7 into the plate-shaped lid 3. This causes a more complex manufacture process and a more expensive production cost.

In addition, the safety vent of the constitution in FIG. 2 is difficult to be made in a small-sized battery such as AA type since the lid 3 is too narrow for the safety vent to be installed therein.

### SUMMARY OF THE INVENTION

It is, therefore, an object of the present invention to provide a safety vent for a battery and a method therefor which are able to safely draw off an internal pressure by virtue of a higher reliability in case of an abnormal rise in the internal pressure of the battery, reduce a production cost by virtue of a simpler manufacture process, and be applied to a narrow space in the battery with more ease.

To achieve the above object, there is provided a safety vent for a battery and a method therefor, the method comprising the steps of forming a vent hole in a bottom of a metal container in advance to draw off the internal pressure of the battery, and then welding an separately manufactured vent on the vent hole by means of a laser welding machine.

It is desirable that the safety vent according to the present invention is installed in each vent plate and thereafter welded to be fixed to the vent hole disposed at the bottom of the metal container.

It is desirable that the vent is separately formed by etching of 0.01˜0.09 mm in depth and 0.05˜1 mm in width at a optional length on the vent plate of about 0.03˜0.1 mm in thickness. Since the slits manufactured in this manner on the vent plate have a relatively uniform depth, the pressure required to open the vent becomes also uniform, whereby the safety vent having the simpler structure and higher reliability as drawn in FIG. 2 can be achieved when the vent is welded to the bottom of the metal container for use.

### BRIEF DESCRIPTION OF THE DRAWINGS

The above and other objects, features and advantages of the present invention will become more apparent from the following detailed description when taken in conjunction with the accompanying drawings, in which:

FIG. 1a and FIG. 1b are schematic views illustrating a general safety vent, which is manufactured by being pressed against a battery metal container;

FIG. 2 is a schematic view illustrating a conventional safety vent, which is comprised in a lid covering a top of a battery;

FIG. 3a is a schematic view illustrating a construction of a vent hole according to the present invention.;

FIG. 3b is a schematic view illustrating a vent plate according to the present invention; and

FIG. 4 is a schematic view illustrating a safety vent according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

Initially, a battery armoring metal container having a vent hole thereon is manufactured by the following process.

The vent hole 11 having a free diameter of 5˜13 mm is formed in a bottom 10 of a stainless steel container having about 33 mm in external diameter, about 55 mm in height, and about 0.35 mm in thickness.

Here, the perforated pattern used for the vent hole has a circular stage 12 which has about 14.5 mm in outer diameter and about 0.3 mm in depth and is projected toward inside of the container, so that a vent plate 20 can be positioned at a fixed place during a welding between the metal container and the vent plate 20, and the circular stage 12 can be formed simultaneously with the vent hole.

Next, the vent plate 20 is manufactured by coating a stainless steel plate of 0.05 mm in thickness with a sensitive film exposed to light, sticking a mask having a desired vent 21 pattern of 0.3 mm in width and 9 mm in length thereon to the stainless steel plate coated with the sensitive film, and irradiating light by means of a UV lamp on them. A vent pattern “+” has been used in the preferred embodiment of the present invention.

Thereafter, the vent plate is manufactured by developing the film and spraying a FeCl3 solution on the developed film, etching the portion, which has not been exposed to light and will become the vent 21 pattern, for 7 to 10 minutes to form slits of 0.02 to 0.03 mm in depth and 0.3 mm in width, and depositing the slits into 5% NaOH solution to remove the film.

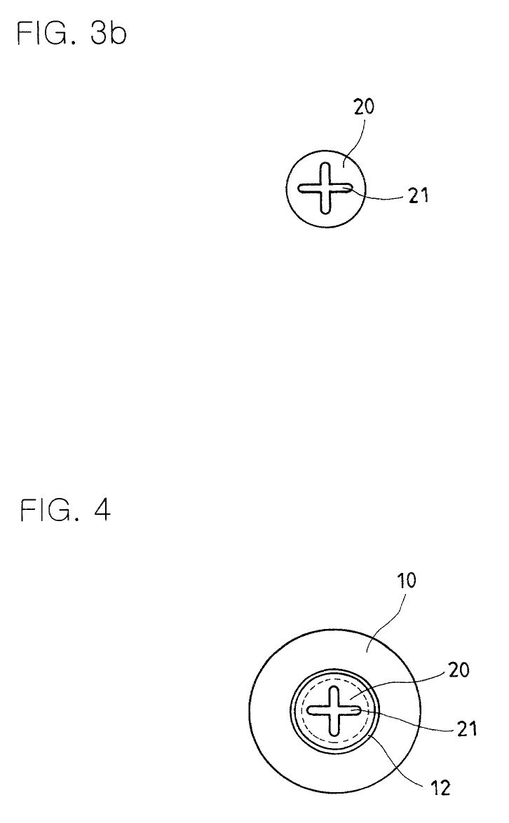

Finally, the stainless steel plate is cut in the circular form having 14.0 mm in diameter so as to have a desired pattern of the vent 21 thereon as shown in FIG. 3b.

The depth etched in this manner on the vent plate 20 has been found to be 202 m after measuring 4 slits per test sample among the total test samples 5EA by means of a stylus type roughness tester made by Mitutoyo, resulting in quite uniform slits.

The metal container and vent plate 20 manufactured in the above process are bonded to each other by putting the vent plate 20 on the outside of the metal container at the position of the vent hole 11 which has already been formed in the bottom 10 of the metal container, and reducing the internal pressure of the container so as for the vent plate 20 to be bonded to the stainless steel container as closely as possible.

Thereafter, the metal container and vent plate 20 are first welded by irradiating laser beam on a weld zone up to less than 50 points, preferably about 25 points after setting a laser energy of Nd:YAG laser welding machine made by NEC as 1.1 KW and a repetition rate as 4. Here, the laser beam is rarely irradiated and the vent plate 20 is bonded in advance to the bottom 10 of the metal container, thereby preventing a thermal distortion of the vent plate 20 generated when a perfect sealing is carried out by higher beam density in the course of a second sealing process. If the perfect hermetical sealing is carried out in the course of the first sealing process, the vent plate 20 would be thermally distorted, crimped and come off, and further possibly burnt by the laser, thereby impeding the working process.

The metal container and vent plate 20 are welded once again during the second welding process by irradiating the laser beam up to more than 200 points, preferably about 250 points, in order to achieve the perfect sealing. The number of points of laser beam irradiated during the second welding process is more than ten times as many as that irradiated during the first welding process.

Meanwhile, the edge of the vent hole inside and outside the metal container, that is to say, inside and outside of the weld zone between the vent plate 20 and the bottom 10 of the metal container is coated with phenolic resin, so that an electrolyte can be prevented from being leaked from the laser-weld zone and from corroding the laser-weld zone.

The coating process is performed by diluting a bond solution of 60% resin with alcohol, which functions as a dissolvent of the bond, coating the weld zone with the diluted substance thinly enough not to influence the pressure required to open the vent, and drying and hardening the coated substance for one hour at temperature 140C.

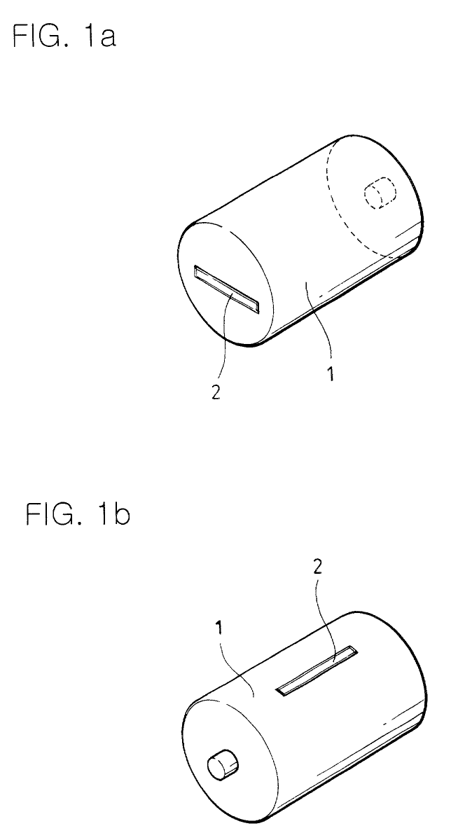

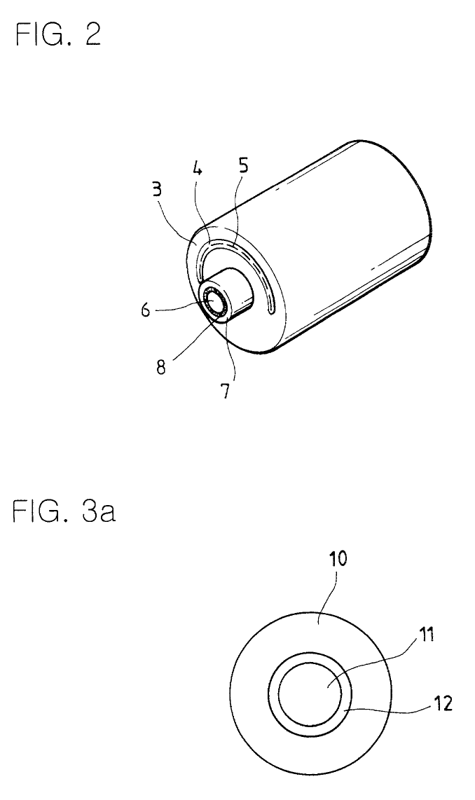

In order to compare the safety vent in the stainless steel container completely hermetical-welded to the vent plate in accordance with the present invention and the safety vent in the conventional stainless steel container having the vent pattern “−” on the outer face thereof as drawn in FIG. 1b, the pressures required to open those vents are measured by applying pressure to the inside of each container with nitrogen gas. Here, the comparison test has been carried with five samples in case of the safety vent of the conventional art and with ten samples in case of the safety vent of the present invention. The test results are the same as shown in Table 1.

TABLE 1

| Sample | Conventional Art (FIG. 1b) | Present Invention |
|---|---|---|
| 1 | 15 | 20 |
| 2 | 24 | 20 |
| 3 | 15 | 20 |
| 4 | 15 | 21 |
| 5 | 50 | 20 |
| 6 | — | 20 |
| 7 | — | 20 |
| 8 | — | 20 |
| 9 | — | 21 |
| 10 | — | 18 |
| Average | 24 | 20 |
| Range | 35 | 3 |

Referring to Table 1, the pressure required to open the safety vent of the conventional art, which is manufactured by being pressed against the stainless steel container to have the vent pattern “−” thereon, is found to have a variation range of 35 kgf/cm2, greatly irregular. The pressure required to open the safety vent according to the present invention has a variation range of 3 kgfcm2, resulting in a comparatively uniform value.

In this regard, the pressure required to open the safety vent according to the present invention is proved to be considerably uniform if compared to that according to the conventional art. Thus, if the internal pressure in the battery abnormally rise, the safety vent in accordance with the present invention would provide higher reliability in preventing the battery explosion caused in case where the safety vent will not open.

In addition, the safety vent according to the present invention has a simpler construction than the conventional safety vent, thereby reducing the production cost and being applicable to such a battery as AA type having a smaller diameter.

It is out of question to those skilled in the art that the safety vent according to the present invention is applicable to all kinds of battery having a higher risk of explosion, including lithium battery.

As described above, the safety vent according to the present invention has an advantage of preventing the possible battery explosion by virtue of its higher reliability since the pressure required to open the safety in the event of abnormal rise in the internal pressure is drastically uniform.

Further, the safety vent according to the present invention has another advantage of reducing the production cost if compared to the conventional safety vent and being applicable to the small-sized battery with more ease since it has a very simpler construction even if it may have the same reliability as the conventional safety vent.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for manufacturing a safety vent for a battery, the method comprising the steps of:
forming a vent hole in a bottom of a battery metal container for receiving a vent plate;
fabricating said vent plate to have a vent thereon;
bonding said vent plate to an outside of said metal container at the position of said vent hole, which is formed in said bottom of said metal container; and
coating an inside and outside of a weld zone between said vent plate and said bottom of said metal container with phenolic resin.

2. The method of claim 1, wherein, in said vent plate fabricating step, said vent hole has a circular stage, which is projected toward an inside of said container to keep said vent plate at a fixed place during bonding between said battery metal container and said vent plate and is formed simultaneously with said vent hole.

3. The method of claim 1, wherein, in said vent plate fabricating step, said vent plate has a thickness of 0.03˜0.1 mm, and said vent formed by etching has a depth of 0.01˜0.09 mm and a width of 0.05˜1 mm.

4. The method of claim 1, wherein, in said bonding step, said vent plate is bonded by putting said vent plate on said outside of said met al container at the position of said vent hole, reducing an internal pressure of said container to contact said vent plate to said bottom of said metal container as closely as possible, and performing a laser welding.

5. The method of claim 4, wherein said laser welding is performed two times: the number of points of laser beam irradiated during a first laser welding is less than one tenth of that irradiated during a second laser welding.

6. A safety vent for a battery, comprising:
a vent hole formed in a bottom of a battery metal container;
a vent plate welded to an outside of said metal container at the position of said vent hole;
a vent formed in said vent plate; and
an inside and outside of a weld zone between said vent plate and said bottom of said metal container coated with phenolic resin.
